(19) United States
(12) Patent Application Publication
(10) Pub. No.: US 2002/0071669 A1
(43) Pub. Date: Jun. 13, 2002

(54) Interconnection device of zoom camera

(76) Inventor: Akio Omiya, Saitama (JP)

Correspondence Address: Arnold International, P.O. Box 585, Great Falls, VA, 22066, US

(21) Appl. No.: 10/002,160

(22) Filed: Dec. 5, 2001

(30) Foreign Application Priority Data
Dec. 11, 2000 (JP) 2000-375539

(51) Int. Cl. G03B 15/06

(52) U.S. Cl. 396/175; 396/379

(57) ABSTRACT

An interconnection device of a zoom camera is constituted of an interconnection gear plate (50) having a large gear (50a) and a cam plate (50b) as an integral part, a drive gear (52) and a transmission gear (53) which are in mesh with the large gear, and an interconnection lever (51) having a cam follower pin engaged with a cam slot of the cam plate. The interconnection lever is engaged with a flash projector (32) of a flash device. As the drive gear rotates in cooperation with the zooming of the zoom lens, the interconnection gear plate moves in a circumferential direction of a lens barrel of the zoom lens. The movement of the interconnection gear plate is transmitted via the transmission gear to a cam member (44), which causes a pair of movable lens elements (41, 42) of a zoom finder (34) to move along an optical axis of the zoom finder. The movement of the interconnection gear plate is also transmitted via the interconnection lever to the flash projector, changing the illuminating angle of the flash device.

### BACKGROUND OF THE INVENTION

1. Field of the Invention

The present invention relates to an interconnection device of a zoom camera, for interconnecting a zoom finder and a zoom flash device to a zoom taking lens.

2. Background Arts

A compact zoom camera is provided with a zoom finder wherein at least a lens element of a finder optical system is movable in an axial direction of the finder optical system, to change its magnification in cooperation with the zoom of the zoom lens. There is also a compact zoom camera having a zoom flash device whose illuminating angle is changed in cooperation with the zooming such that the illuminating angle gets narrower as the zoom lens moves to the telephoto side.

This type of compact zoom camera has an interconnection mechanism for making the zoom finder and the zoom flash device cooperate with the zoom lens. As an example of such an interconnection mechanism, JPU 2-78937 discloses a flat cam plate that is provided with three cam grooves and slides with the zooming of a zoom lens. Two of the three cam grooves actuate two movable lens elements of a finder optical system to move to change the finder magnification, whereas another one of the three cam grooves actuates a flash discharge tube to move back and forth to change the illuminating angle.

In a camera as disclosed in JPA 5-197000, a drive gear, which rotates in cooperation with the zooming of a zoom lens, is coupled through an interconnection gear train to a helical cam that rotates about an axis parallel to an optical axis of a finder. Two movable lens of the finder move axially with the rotational movement of the helical cam, thereby to change the magnification. The interconnection gear train is also coupled to a rack in an intermediate position of the train, and the rack is coupled to a swing lever. As the rack moves linearly in a perpendicular direction to the finder optical axis, the swing lever swings to move a flash discharge tube back and forth, thereby to change the illuminating angle of a flash device.

In another camera as disclosed in JPA 9-211556, a drive gear rotating in cooperation with the zooming of a zoom lens interlocks with a first interconnection gear. The first interconnection gear is integrally coupled to a first helical cam that rotates about an axis parallel to a finder optical axis. As the first helical cam rotates, a couple of movable lens of a finder optical system moves to change the magnification. The rotational movement of the first interconnection gear is further transmitted to a second interconnection gear that is integrally coupled to a second helical cam. The rotational movement of the second helical cam causes a flash discharge tube to move back and forth, changing the illuminating angle of a flash device.

The interconnection mechanisms of the former two zoom cameras need a certainly large space enough for the movement of the cam plate or the rack, so it is difficult to make the camera compact. Also because a clearance is provided in the engagement between the cam groove and the finder movable lenses, the positioning accuracy of these lenses is so lowered that there is a difference between the image magnification of the zoom lens and the field magnification of the viewfinder. Although the interconnection mechanism of the latter zoom camera, where the first and second helical cams are rotated through a gear mechanism, is superior in positioning accuracy, the mechanism inevitably takes a large space, contradicting the need for compactness.

### SUMMARY OF THE INVENTION

In view of the foregoing, an object of the present invention is to provide an interconnection device of a zoom camera, for interconnecting a zoom lens to a viewfinder and a flash device so as to change the magnification of the viewfinder and the illuminating angle of the flash device in correspondence with the zooming of the zoom lens, that needs a smaller mounting space, and is superior in positioning accuracy of movable lenses of a zoom finder.

According to the present invention, an interconnection device of a zoom camera, for interconnecting a zoom finder and a flash device to a zoom lens so as to change the magnification of the zoom finder and the illuminating angle of the flash device in correspondence with the zooming of the zoom lens comprises: a drive gear that rotates in cooperation with zooming of the zoom lens; a control member formed integral with a gear and a cam plate having a cam slot, the gear meshing with the drive gear such that the control member moves with the rotation of the drive gear, in a direction perpendicular to an optical axis of the zoom lens; a cam member engaged with at least a movable lens of the zoom finder, the cam member being coupled to the gear of the control member through a transmission gear such that the cam member rotates about a parallel rotary axis to the optical axis of the zoom lens, along with the movement of the control member, causing the movable lens to move along an optical axis of the zoom finder that extends parallel to the optical axis of the zoom lens, thereby to change the magnification of the zoom finder; and an interconnection member engaged with the cam slot of the cam plate, and coupled to a flash projector of the flash device such that the interconnection member causes the flash projector to move toward or apart from a condenser lens of the flash device, along with the movement of the control member, thereby to change the illuminating angle of the flash device.

According to a preferred embodiment, the control member is a plate member that is curved along a circumferential surface of a fixed lens barrel of the zoom lens, and is mounted on the circumferential surface so as to be movable in the circumferential direction of the fixed lens barrel.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 shows a front perspective view of a zoom camera according to an embodiment of the present invention;

FIG. 2 shows a rear perspective view of a zoom camera according to the embodiment of FIG. 1;

FIG. 3 shows a perspective view of a viewfinder unit of the zoom camera of FIG. 1; and

FIG. 4 shows an exploded perspective view of an interconnection mechanism provided between the viewfinder unit and a zoom lens.

### DETAILED DESCRIPTION OF THE EMBODIMENTS

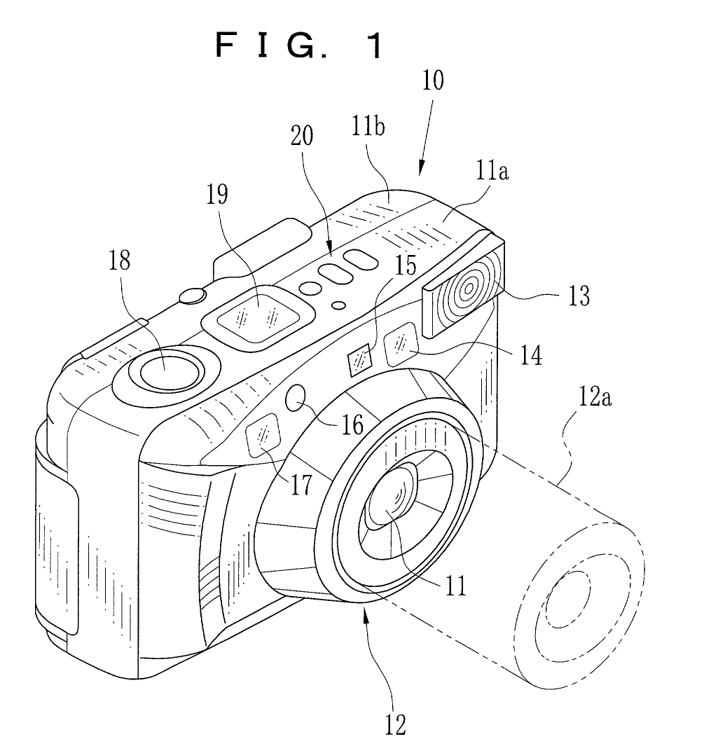

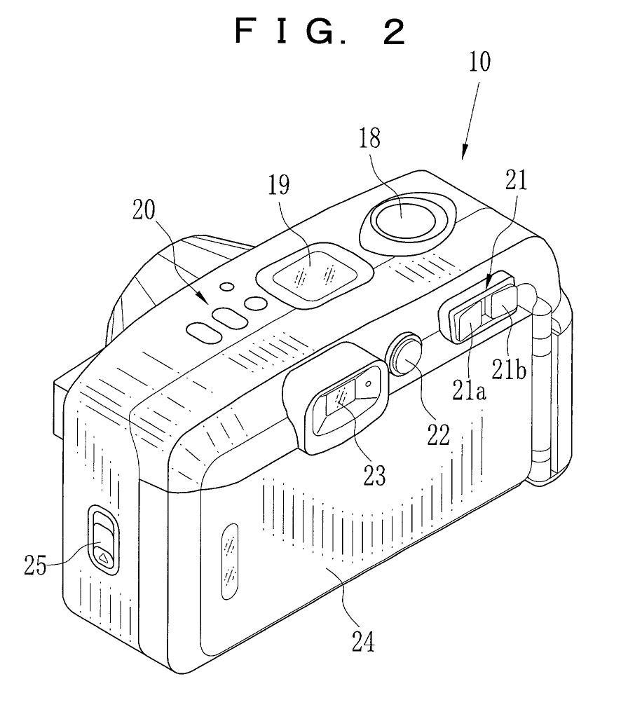

In FIG. 1, a camera 10 has on its front side a zoom lens 11, a lens barrel 12, a flash window 13, an autofocus light emitting window 14, a finder objective window 15, a photometry window 16 and an autofocus light receiving window 17. On the top of the camera 10 are provided a shutter button 18, an LCD panel 19, setup switches 20 and so on. As shown in FIG. 2, zoom buttons 21, a power switch 22, a finder eyepiece window 23 and a rear lid 24 are provided on the rear of the camera 10. Designated by 25 is a knob for opening the rear lid 24.

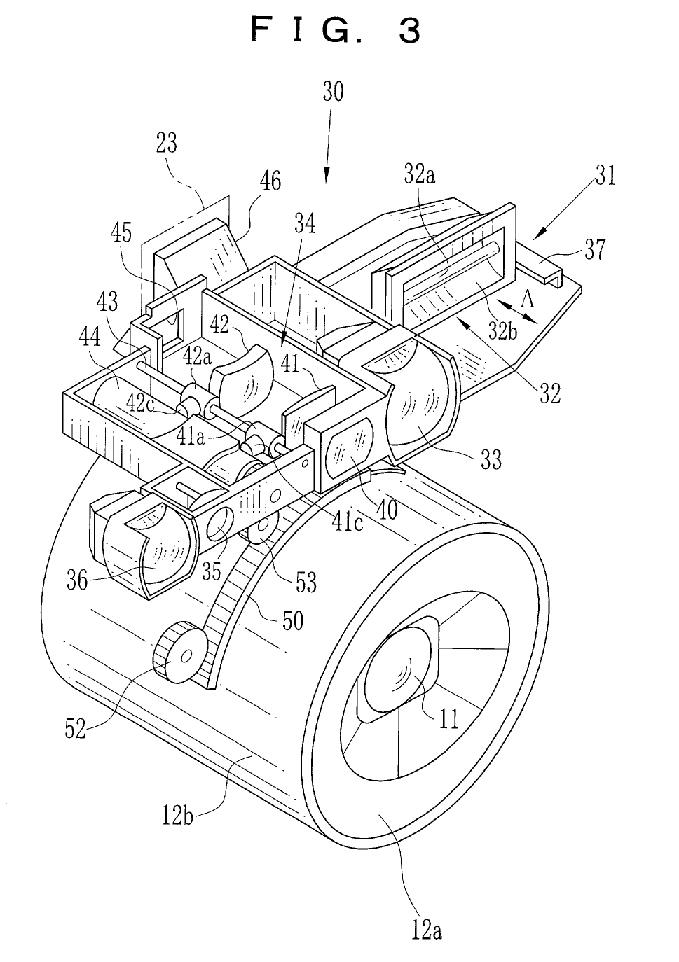

The lens barrel 12 consists of a movable barrel portion 12a holding the zoom lens 11 therein, and a fixed barrel 12b that is located inside the camera 10, as shown in FIG. 3. As the movable barrel portion 12a is rotated about an optical axis of the zoom lens 11 through a motor-driven zooming mechanism that is not shown but mounted in the camera 10, the zoom lens 11 moves along the optical axis, changing the focal length and thus the magnification thereof. The zooming mechanism is actuated by operating the zoom buttons 21.

The zoom buttons 21 include a wide button member 21a and a tele button member 21b. Pressing the wide button member 21a makes the zoom lens 11 move toward a wide-angle end where the movable barrel portion 12a is retracted into the camera 10, as shown by solid lines in FIG. 1, and the zoom lens 11 has the shortest focal length. Pressing the tele button member 21b makes the zoom lens 11 move toward a telephoto end where the movable barrel portion 12a fully protrudes out of the camera 10, as shown by phantom lines, and the zoom lens 11 has the longest focal length.

The LCD panel 19 displays a photography mode selected by operating the setup switches 20 and other information on the camera 10. The flash window 13 is covered with a protector that serves as a condenser lens for projecting a flash light toward a photographic field of the zoom lens 11. The protector is usually made of a Fresnel lens.

A finder unit 30 is disposed inside the camera 10 above the lens barrel 12, as shown in FIG. 3. The finder unit 30 is provided with a movable flash projector 32, an autofocus light emitting section 33, a real image type zoom finder 34, a photo sensor 35 and an autofocus light receiving member 36, which are located in correspondence with the flash window 13, the autofocus light emitting window 14, the finder objective window 15, the photometry window 16 and the autofocus light receiving window 17 respectively.

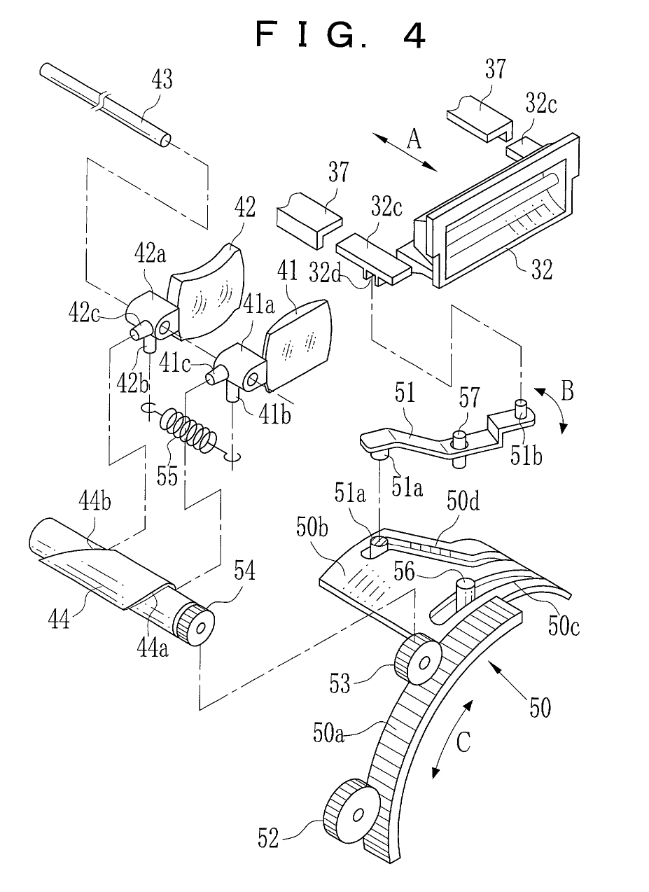

The flash projector 32 consists of a flash discharge tube 32a and a reflector 32b, and is engaged at its guide legs 32c with a pair of guide rails 37, as shown in FIG. 4, so that the flash projector 32 is movable back and forth in parallel to an optical axis of the zoom lens 11, as indicated by an arrow A. The flash projector 32 and the guide rails 37 constitute a zoom flash device 31. The autofocus light projector 33 and the autofocus light receiving member 36 are provided for measuring the subject distance through the trigonometric method, to focus the zoom lens 11 automatically in accordance with the measured subject distance. The photo sensor 35 measures the subject brightness, to use it for automatic exposure control. The measured subject brightness is also compared to a threshold value, to activate the flash projector 32 when the subject brightness is below the threshold value.

The zoom finder 34 is constituted of an objective lens 40, first and second movable lens 41 and 42, a guide rod 43, a finder zooming cam 44 and other minor elements. The finder zooming cam 44 rotates about a parallel rotary axis to the optical axis of the zoom lens 11. Light entering through the objective lens 40 travels through the movable lenses 41 and 42, forming an image of a subject on a light entering surface of a prism 46 that is placed behind an opening 45. A light exiting surface of the prism 46 is located in opposition to the finder eyepiece window 23, so the photographer can view the subject image through the eyepiece window 23.

An interconnection gear plate 50 is disposed as a power transmission member between the finder unit 30 and the lens barrel 12. The interconnection gear plate 50, the finder zooming cam 44 and an interconnection lever 51 constitute an interconnection mechanism for interconnecting the zoom finder 34 and the zoom flash device 31 to the zoom lens 12. The interconnection gear plate 50 is formed with a large gear 50a and a cam plate 50b as an integral part. The large gear 50a and the cam plate 50b are curved along the circumferential surface of the lens barrel 12. That is, the interconnection gear plate 50 is shaped into a circular arc, and is mounted movable in the circumferential direction of the lens barrel 12, as indicated by an arrow C.

The large gear 50a meshes with a drive gear 52 at a lateral side of the lens barrel 12, and with a transmission gear 53 at an upper side of the lens barrel 12. The drive gear 52 is coupled to the not-shown motor that drives the zooming mechanism of the zoom lens 11. So the driving power is supplied via the drive gear 52 to the interconnection mechanism during the zooming of the zoom lens 11. The transmission gear 53 meshes with a gear portion 54 that is formed around one end of the finder zooming cam 44. Accordingly, the finder zooming cam 44 rotates about the rotary axis as the drive gear 52 and thus the transmission gear 53 rotate with the zooming of the zoom lens 11.

The finder zooming cam 44 is provided with first and second cam surfaces 44a and 44b which have different angles of slant to the rotary axis. On the other hand, the first and second movable lenses 41 and 42 are supported on the guide rod 43 through supporting portions 41a and 42a, so as to be movable along the guide rod 43. The movable lenses 41 and 42 are urged toward each other by a coiled spring 55 that is bridged between bottom pins 41b and 42b of the supporting portions 41a and 42a. Thereby, engaging pins 41c and 42c protruding laterally from the supporting portions 41a and 42a are respectively kept in contact with the cam surfaces 44a and 44b, as nipping the cam surfaces 44a and 44b between the pins 41c and 42c.

The cam plate 50b is formed with a guide slot 50c and a cam slot 50d. The guide slot 50c is engaged with a pin 56 that is provided on a fixed lens barrel member 12b surrounding the movable lens barrel portion 12a. The cam slot 50d is engaged with a cam follower pin 51a that is formed on the interconnection lever 51. The interconnection lever 51 is pivotally mounted on an axle interconnection lever 51 at an intermediate portion, wherein the axle 57 is formed vertically on a not-shown internal frame of the camera 10, so the interconnection lever 51 rotates in a horizontal plane, as indicated by an arrow B. An engaging pin 51b is formed on the opposite end of the interconnection lever 51 from the cam follower pin 51a. The engaging pin 51b is engaged in an engaging groove 32b that is formed on the bottom of one of the guide legs 32c of the flash projector 32.

The interconnection mechanism structured as above operates as follows:

With the zooming of the zoom lens 11, the drive gear 52 rotates to move the interconnection gear plate 50 in the circumferential direction C of the lens barrel 12. The movement of the interconnection gear plate 50 is transmitted through the large gear 50a, the transmission gear 53 and the gear portion 54 to the finder zooming cam 44. As the finder zooming cam 44 rotates, the engaging pins 41c and 42c slide on the cam surfaces 44a and 44b, thereby moving in the direction of the rotary axis of the finder zooming cam 44. As a result, the movable lenses 41 and 42 change their position in the axial direction, and thus change the magnification of the zoom finder 34.

Simultaneously, the movement of the interconnection gear plate 50 is transmitted through the engagement of the cam slot 50d with the cam follower pin 51a to the interconnection lever 51, ceLusing the interconnection lever 51 to rotate about the axle 57. Then, the flash projector 32 as engaged with the engaging pin 51b is moved in the axial direction A along the guide rails 37, to change the illuminating angle of the flash light. As the flash projector 32 moves rearward apart from the flash window 13, the illuminating angle decreases, and thus the illuminating range gets narrower. On the contrary, as the flash projector 32 moves forward and thus approaches the flash window 13, the illuminating angle increases, and thus the illuminating range gets wider. In this way, the magnification of the zoom finder 34 and the illuminating angle of the flash device 31 change with the zooming of the zoom lens 11.

Since the finder zooming cam 44 is driven through a gear train consisting of the drive gear 52, the large gear 50a, the transmission gear 53 and the gear portion 54, it is possible to position the movable lenses 41 and 42 with accuracy. Since the large gear 50a and the cam plate 50b are formed integrally as a flat member, the interconnection mechanism needs a small mounting space. Since the interconnection gear plate 50 is curved along the circumferential surface of the lens barrel 12, and is moved in the circumferential direction C of the lens barrel 12, the interconnection mechanism contributes to compactness of the camera 10.

The overall operation of the zoom camera 10 will be briefly described below.

The photographer looks into the finder eyepiece window 23 to frame a subject and, if necessary, operates the wide button member 21a or the tele button member 21b of the zoom buttons 21 for selecting the magnification of the zoom lens 11. In response to the operation on the zoom buttons 21, the not-shown motor rotates the lens barrel 12 to move between the wide-angle end and the telephoto end. Simultaneously, the driving power of the motor is transmitted through the drive gear 52 to the interconnection mechanism, so the zoom finder 34 changes its magnification in correspondence with the magnification of the zoom lens 11, and also the zoom flash device 31 changes its illuminating angle in correspondence with the photographic field of the zoom lens 11, in the way as described above.

Thereafter when the shutter button 18 is pressed, the subject brightness and the subject distance are measured in a short moment through the photo sensor 35 and through the autofocus light projector 33 and the autofocus light receiving member 36, respectively. After the zoom lens 11 is focused on the basis of the measured subject distance, a not-shown shutter mechanism is activated to expose photo film at an exposure value determined by the measured subject brightness. If the subject brightness is below the threshold value, the flash projector 32 is activated in synchronism with the exposure.

Although the interconnection gear plate 50 of the above embodiment is curved along the circumferential surface of the lens barrel 12, it is possible to use an even interconnection gear plate instead, and dispose it above a finder unit.

Thus, the present invention is not to be limited to the above embodiment but, on the contrary, various modifications will be possible to those skilled in the art without departing from the scope of claims appended hereto.

What is claimed is:

1. An interconnection device of a zoom camera, for interconnecting a zoom finder and a flash device to a zoom lens so as to change the magnification of the zoom finder and the illuminating angle of the flash device in correspondence with the zooming of the zoom lens, said interconnection device comprising:
a drive gear that rotates in cooperation with zooming of the zoom lens;
a control member formed integrally with a gear and a cam plate having a cam slot, said gear meshing with said drive gear such that said control member moves with the rotation of said drive gear, in a direction perpendicular to an optical axis of the zoom lens;
a cam member engaged with at least a movable lens of the zoom finder, said cam member being coupled to said gear of said control member through a transmission gear such that said cam member rotates about a parallel rotary axis to the optical axis of the zoom lens, along with the movement of said control member, causing said movable lens to move along an optical axis of the zoom finder that extends parallel to the optical axis of the zoom lens, thereby to change the magnification of the zoom finder; and
an interconnection member engaged with said cam slot of said cam plate, and coupled to a flash projector of the flash device such that said interconnection member causes said flash projector to move toward or apart from a condenser lens of the flash device, along with the movement of said control member, thereby to change the illuminating angle of the flash device.

2. An interconnection device as recited in claim 1, wherein said control member is a plate member that is curved along a circumferential surface of a fixed barrel of the zoom lens, and is mounted on said circumferential surface so as to be movable in the circumferential direction of said fixed lens barrel.

3. An interconnection device as recited in claim 2, wherein said cam plate has a guide slot engaged with a pin that is formed on said circumferential surface of said fixed barrel, said guide slot extending in the circumferential direction of said fixed barrel, to guide said control member in the circumferential direction.

4. An interconnection device as recited in claim 1, wherein said interconnection member is a lever mounted above said cam plate so as to be rotatable about a vertical axis, said lever having at one end a cam follower pin engaged with said cam slot, and being engaged with said flash projector at an opposite end.
